(19) United States
(12) Patent Application Publication
(10) Pub. No.: US 2022/0221600 A1
(43) Pub. Date: Jul. 14, 2022

(54) RADIATION DETECTOR

(71) Applicant: QUEEN MARY UNIVERSITY OF LONDON, London, Greater London (GB)

(72) Inventors: Theo KREOUZIS, London, Greater London (GB); Cozmin TIMIS, London (GB); William GILLIN, London (GB); Adrian BEVAN, London (GB); Xiaoqi LIU, London (GB)

(73) Assignee: QUEEN MARY UNIVERSITY OF LONDON, London, Greater London (GB)

(21) Appl. No.: 17/603,285

(22) PCT Filed: Apr. 9, 2020
(86) PCT No.: PCT/GB2020/050924

§ 371 Date: Oct. 12, 2021

(30) Foreign Application Priority Data
Apr. 12, 2019 (GB) 1905234.9
Apr. 24, 2019 (GB) 1905723.1

(51) Int. Cl. G01T 3/08; G01T 1/24

(52) U.S. Cl. CPC G01T 3/08; G01T 1/24

(57) ABSTRACT

A radiation detector comprising a transistor, e.g. a FET, formed of one or more organic semiconductor materials having a neutron sensitizer element dispersed therein. The sensitizer element is one or more elements selected from the group consisting of boron, cadmium, lithium and gadolinium. The semiconductor device comprises a diode, a transistor (e.g. a Field Effect Transistor) or a non-rectifying, symmetric, semiconductor device. The organic semiconductor materials comprise a donor organic semiconductor material and an acceptor organic semiconductor material or a combination of organic and inorganic donor- acceptor materials.

### FIELD OF THE INVENTION

The present invention relates to radiation detectors, in particular to neutron detectors using organic semiconductor materials and to methods of manufacture thereof.

### BACKGROUND

The most basic form of an organic radiation detector is a Shockley diode, in which the semiconductor is sandwiched between anodes and cathodes of different materials (with different workfunctions). Reverse biasing such a device will allow charge to flow when incident radiation deposits energy in it. There are many ways to improve this structure, including making layers of intrinsic and/or doped semiconductor sandwiched between anode and cathode (e.g. pn and pin diodes, etc.) and blending different types of organic semiconductor in order to effectively create a donor/acceptor organic matrix to improve sensitivity.

The electrodes of such a radiation detector can be arranged as pads, strips or pixels to make single channel or multichannel (position sensitive) devices. These structures can be made as thick or thin 2D devices, or stacked to create 3D devices that may be read out as single or multi-channel sensors. Such devices can be operated in low voltage mode (a few tens of volts reverse bias), or with high voltage (avalanche mode).

To detect neutrons, thin layers of boron are applied next to the sensitive region of semiconductor. It has also been proposed to construct columns or pillars of boron, for example see [Ref 1]. Boron neutron capture releases alpha particles, with a lithium recoil that is the source of secondary radiation that makes these devices efficient. There is a limitation on efficiency provided by the limited range of an alpha particle in material. For silicon this is a few microns, and a similar range is found for organic material. An efficiency of 35% is considered state of the art for solid state detectors of this type, where towers of boron are embedded into the semiconductor matrix in a complicated fabrication process.

### SUMMARY

There is therefore a need for improved neutron detectors, in particular detectors with increased efficiency and which can be manufactured at lower cost.

According to the present invention, there is provided a radiation detector comprising a transistor device formed of one or more organic semiconductor materials having a neutron sensitizer element dispersed therein.

The transistor may be a Field Effect Transistor.

The sensitized semiconductor layer be provided in the channel of the field effect transistor or in a layer of organic semiconductor adjacent the gate of the field effect transistor.

An additional semiconductor layer containing sensitizer may be provided.

The sensitizer element may be one or more elements selected from the group consisting of boron, cadmium, lithium and gadolinium.

The sensitizer element may be provided in an amount of between 1×10²⁶ atoms/m³ and 1×10²⁸ atoms/m³ within the organic semiconductor material.

The sensitizer element may be provided in the form of particles dispersed in the organic semiconductor material.

The sensitizer element may be contained in an organic compound.

The sensitizer element may be provided in the form of a plurality of layers embedded in the organic semiconductor material.

The organic semiconductor material desirably has a charge carrier mobility of at least 10⁻ cm²V⁻¹s⁻¹.

The organic semiconductor materials may comprise a donor organic semiconductor material and an acceptor organic semiconductor material or a combination of organic and inorganic donor-acceptor materials.

The donor organic semiconductor component may be electron-rich (has a smaller electron affinity) compared to the acceptor component.

The acceptor component may be electron-deficient (has a larger electron affinity) compared to the donor, for example fullerene, fullerene derivative, pi-conjugated polymer, small molecule or perovskite.

The semiconductor device may have a thickness in the range of from 1 μm to 500 μm.

The radiation detector may further comprise a bias voltage source configured to apply a potential difference in the range 1 V to 1 kV.

The radiation detector may contain sensitizer components additional to the neutron sensitizer, for example X-ray absorbers dispersed in the organic semiconductor material, the X-ray absorber comprising an element having an atomic number greater than 20.

According to the invention, there is also provided an object detector comprising a radiation detector as described above and a neutron source.

Thus, the present invention can provide a neutron detector which has a sufficient efficiency and can be manufactured in a variety of different forms at low cost.

### BRIEF DESCRIPTION OF THE FIGURES

Exemplary embodiments of the invention are described below with reference to the accompanying figures, in which:

FIG. 1 depicts in cross-section a diode described for reference in explaining the principle of the invention;

FIG. 2 depicts energy levels in the diode of FIG. 1;

FIG. 3 depicts the relative detection efficiency versus detector area for a range of organic semiconductor device efficiencies.

FIGS. 4(a) and 4(b) present transient a particle signals obtained using a P3HT based diode in avalanche operation;

FIG. 5 depicts in cross-section a FET forming part of a radiation detector according to an embodiment of the invention;

FIG. 6 depicts in cross-section a FET forming part of a radiation detector according to another embodiment of the invention; and

FIG. 7 depicts an object detector according to an embodiment of the invention.

In the various figures, like parts are denoted by like references.

### DETAILED DESCRIPTION OF EMBODIMENTS

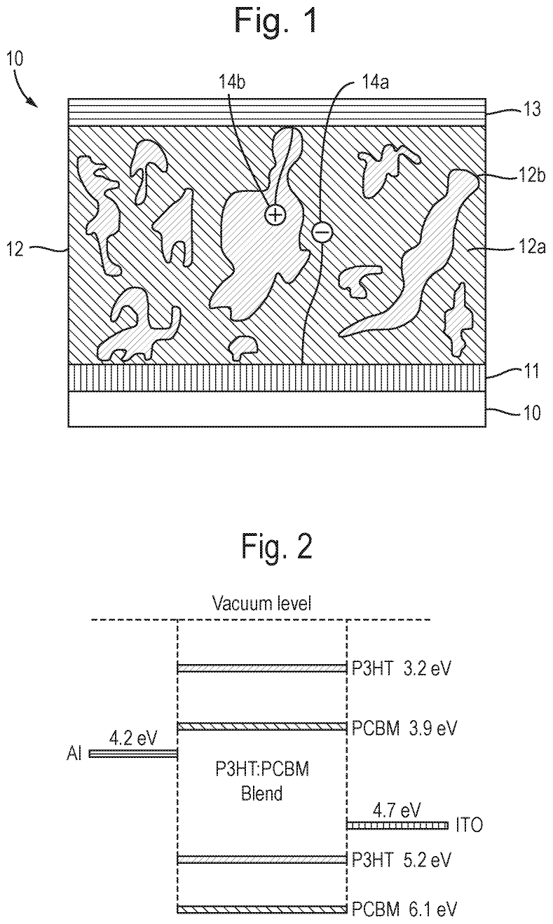

FIG. 1 depicts a diode 1 which may form the radiation sensitive part of a neutron detector. Diode 1 comprises a substrate 10 on which is formed a first electrode (e.g. anode) 11, an organic semiconductor layer 12 and a second electrode (e.g. cathode) 13. The organic semiconductor layer 12 comprises two components: an acceptor 12a and a donor 12b. Either or both of the acceptor 12a and donor 12b have a sensitizer element dispersed therein. The sensitizer element can be provided in a sensitizer compound, e.g. boron nitride (BN) (given the natural abundance of the ¹⁰B isotope, no enrichment is necessary, but is possible if desired). Other suitable sensitizer elements include cadmium, lithium and gadolinium, which can be provided in the form of suitable sensitizer compounds. Suitable techniques for formation of the acceptor 12a and donor 12b are described below. The first electrode can be the cathode and second the anode. In the following description, the term “sensitizer” is used to refer to either a sensitizer element or a sensitizer compound.

In use, the diode can be biased by applying a potential difference between the first and second electrodes 11, 13. The diode can be either forward or reverse biased. The diode can also be intrinsically biased by the use of electrodes of different materials.

When energy is deposited in the semiconductor layer, e.g. by incident radiation, electron-hole pairs are produced across the semiconductor bandgap. Negative charge carriers (electrons) 14a collect in the acceptor 12a and positive charge carriers (holes) 14b collect in the donor 12b. Current can therefore flow until the charge carriers recombine with each other or in the electrodes. Thus, incident radiation can be detected as an increased current through the diode.

Detection of neutrons is achieved through the presence of the nuclei of the sensitizer element (e.g. boron) dispersed within the bulk of the organic semiconductor layer. In the event that a neutron is captured by a boron nucleus, an alpha particle is emitted and a lithium ion recoils:

¹⁰B+nₜₕₑ(0.025 eV)→⁴He²⁺+⁷Li³⁺+2.79 MeV (6%)

¹⁰B+nₜₕ(0.025 eV)→⁴He²⁺+⁷Li³⁺+2.31 MeV+γ(0.48 MeV) (94%)

The ionizing radiation (e.g. alpha particle, recoil daughter nucleus) emitted post neutron capture by the sensitizer element is used to increase the mobile charge carrier density within the semiconducting components of a device and cause an increase in the device current. The ionizing radiation energy is lost to the semiconducting components, exciting electron-hole pairs across the bandgap, the dissociation of which can be aided by the use of donor-acceptor (D-A) interfaces (see FIG. 2).

The increase in device current can be detected in the steady state (e.g. by the use of a suitable shutter mechanism and/or phase locked amplification) or detected in the transient response of a device (using charge sensitive and/or voltage pre-amplification). In all cases the device drive conditions are chosen to maximize the signal to noise ratio. Embodiments can employ avalanche mode detection or low voltage detection. It will be appreciated that any property of the semiconductor device that changes observably in the presence of neutron radiation can be measured to detect radiation. The device may be used in a mode which simply detects the presence of a neutron flux (greater than a threshold) or may be calibrated to measure the magnitude of the flux.

The sensitizer, e.g. boron, can be dispersed or embedded in the bulk of the organic semiconductor in any convenient way, for example in thin layers, particulates (e.g. ion implanted or mixed in nanoparticles or microscopic powders), or via boron containing organic molecules. In embodiments of the invention, the integrated active volume of the detector is maximized, and the whole of the device can potentially be used to detect a neutron incident on a detector. An ideal organic device with embedded boron, relative to a planar device with boron on the surface, has a ratio of active volumes varying between 1 and 20 for a 5 to 7 MeV alpha particle in a device of thickness between a few μm and 100 μm. Desirably, the thickness of the organic semiconductor (OSC) layer is of the order of the Bragg peak position e.g. between 1 and 100 μm.

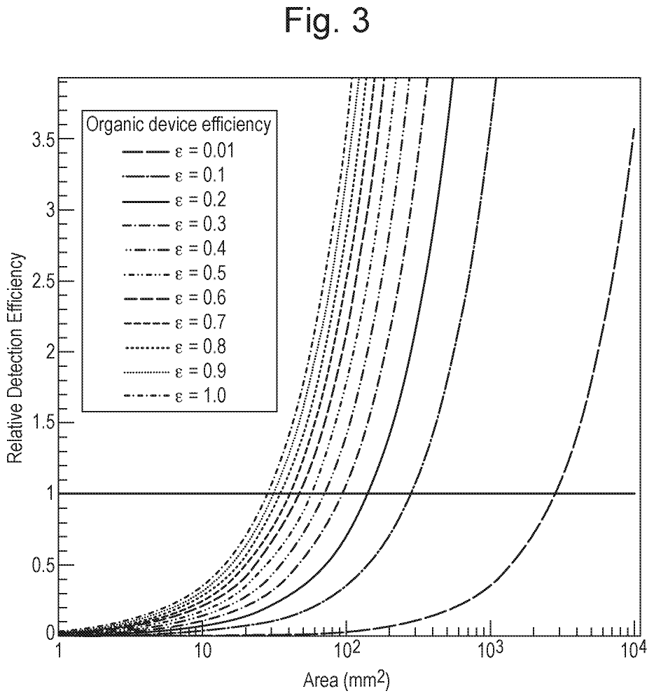

Known detectors have a high intrinsic efficiency, but small area and are expensive to manufacture. Embodiments of the invention can have a large area and be cost effective even if there is a small intrinsic efficiency as the relative detection efficiency for a source depends on the product of intrinsic efficiency times area of detector. Comparing existing silicon detector devices to material costs for organic devices of the same area a factor of 50 cost saving can be expected. An ideal silicon DSMSND of [Ref 1] has a value of 35% intrinsic efficiency so that an organic semiconductor device according to an embodiment of the invention can be made large enough to have the same relative efficiency as a given silicon device cost effectively even if the semiconductor device has an intrinsic efficiency as low as 1%. This is illustrated in FIG. 3, where the relative device efficiency versus detector area is plotted for devices of varying (intrinsic) efficiency. The horizontal line illustrates how equal relative efficiency can be achieved using lower efficiency devices by increasing the active area.

The average amount of boron as sensitizer element in the organic semiconductor layer is desirably greater than or equal to about 5×10²⁶ atoms/m³, more desirably greater than or equal to 1×10²⁷ atoms/m³. These figures apply to naturally occurring boron, if the proportion of ¹⁰B is enriched, the concentration may be correspondingly reduced. For Li as the sensitizer element the concentration is desirably at least 1×10²⁷ atoms/m³, more desirably greater than or equal to 5×10²⁷ atoms/m³. For Gd as the sensitizer element the concentration is desirably at least 1×10²⁶ atoms/m³, more desirably greater than or equal to 5×10²⁶ atoms/m³. For Cd as the sensitizer element the concentration is desirably at least 5×10²⁶ atoms/m³, more desirably greater than or equal to 1×10²⁷ atoms/m³. If the amount of sensitizer is too low, the detector efficiency may be too low.

The amount of boron as sensitizer element in the organic semiconductor layer is desirably no more than about 5×10²⁷ atoms/m³, more desirably no more than about 2×10²⁷ atoms/m³. For Li as sensitizer element in the organic semiconductor layer is desirably no more than about 5×10²⁷ atoms/m³, more desirably no more than about 2×10²⁷ atoms/m³. For Gd as sensitizer element in the organic semiconductor layer is desirably no more than about 1×10²⁷ atoms/m³, more desirably no more than about 5×10²⁶ atoms/m³. For Cd as sensitizer element in the organic semiconductor layer is desirably no more than about 1×10²⁸ atoms/m³, more desirably no more than about 2×10²⁷ atoms/m³. If the amount of sensitizer element is too high it may affect the properties of the organic semiconductor in an undesirable manner. Although detector efficiency improves with increased amount of sensitizer element, if the amount of sensitizer element is too large there is no further increase in detector efficiency because the organic semiconductor layer becomes opaque to neutrons. The inventors have determined that amounts of sensitizer elements in the above ranges are not detrimental to the functioning of the organic semiconductor device.

The sensitizer can be dispersed within a bulk heterojunction or within the polymer layer of a polymer:perovskite layered device or can be constrained within one or more layers in a multilayer device. The sensitizer component is not expected to form any percolation (charge) pathway at such low concentrations. The sensitizer may act as a barrier or trap for different charge polarities and may lead to essentially unipolar or ambipolar devices (barriers can be circumvented at low concentrations, whereas traps cannot). Trapping one polarity of carrier can lead to current gain effects which may be desirable.

The first and second electrodes (anode and cathode) can be made of the same material, in which case no intrinsic bias is created and an external bias is used to drive the device which does not display rectification. Alternatively, electrodes can be made with materials with different work functions to ensure that an in built bias exists. Any conductive material can be used for the electrodes as is convenient for manufacturing, such as indium tin oxide (ITO), Au, poly(3,4-ethylenedioxythiophene) polystyrene sulfonate (PEDOT-PSS) or aluminum.

As a proof of concept, test devices were fabricated by dropcasting 0.5 mL of 1:1 mass ratio solution of P3HT:PCBM in Dichlorobenzene onto pre-patterned Indium Tin Oxide (ITO) coated glass substrates with concentrations varying between 10 and 40 mg/mL. A neutron sensitizer component consisting of 1±0.5 wt % BN nanoparticles (70-90 nm diameter) was incorporated by suspending the nanoparticles in the organic semiconductor solution prior to deposition. After drying, a ˜100 nm Al cathode was deposited by vacuum evaporation (typically 10⁻⁶ mbar base pressure) at ˜2 nm s⁻¹. The resulting typical individual diode area was 4 mm². A schematic sample structure is shown in FIG. 1 where the BN nanoparticles were included throughout the organic semiconductor donor-acceptor layer. All fabrication was carried out in a nitrogen filled glovebox. The samples were transferred into the relevant sample chambers under nitrogen and all subsequent measurements carried out under vacuum (typically 10⁻⁵ mbar base pressure). After all measurements were completed, the individual sample thickness (typically 5-38 μm) was measured using a Veeko DekTak profilometer.

To test functioning as a radiation detector, the test devices were exposed to a particles by mounting them with the Al cathode facing an ²⁴¹Am source at a distance of 7 mm separated by a moveable shutter. The measured α particle flux under these conditions was 625 mm⁻² s⁻¹ at the sample position. Current-Voltage (I-V) measurements were carried out between ±20 V bias using a Keithley 4200 source-measure unit with the shutter alternatively open and closed and repeated 16 times. In the absence of exposure the diode displayed reasonable rectifying behavior, as expected from the work function difference between anode and cathode (see FIG. 2). The current increase under exposure was clearly observable under both forward and reverse bias at modest drive conditions, between 10 and 20 V applied across the sample i.e. at small applied electric fields, <˜1 V μm⁻¹.

The test devices demonstrated steady state a detection using P3HT:PCBM based diode devices (with OSC layer thickness between 5 and 38 μm) using low bias (<20 V) with useful reproducible and repeatable sensitivities.

The device particle detection sensitivity (and associated gain efficiency product) is optimized by choosing the OSC layer thickness to correspond to the Bragg peak position for the 5.49 MeV particles used (obtained by modelling). For OSC layers smaller than the Bragg peak position, devices are charge generation limited, whereas for those larger than the Bragg peak position, devices appear charge collection limited. Transient photoconduction measurements confirm electron trapping and return hole mobility lifetime values consistent with Hecht equation fitting of the particle detection sensitivity.

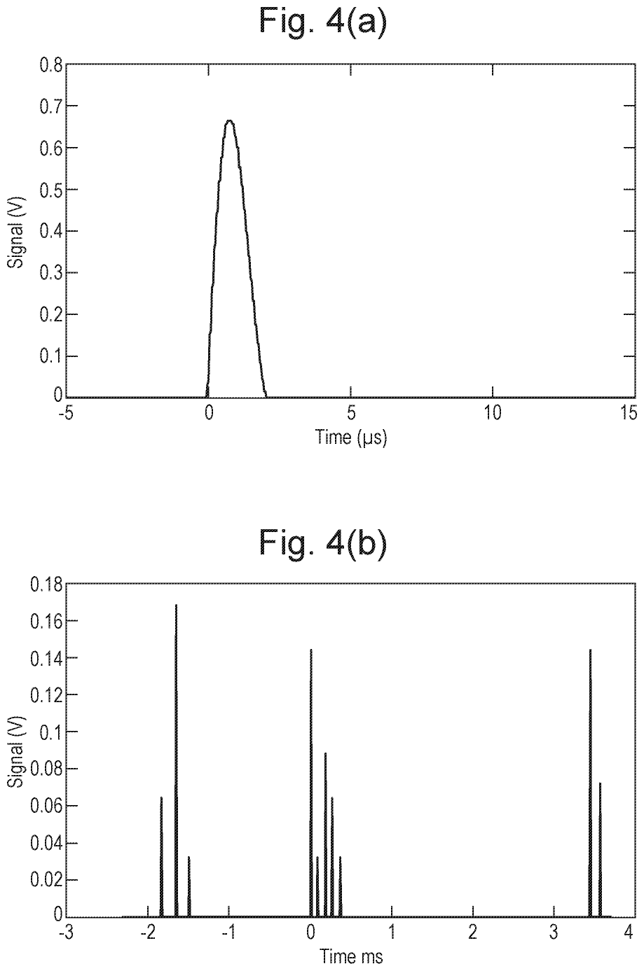

On the basis of demonstrated a particle detection, it can be expected that neutron detection can be achieved by detecting a particles emitted on the capture of thermal neutrons by boron nuclei dispersed in the organic semiconductor layer. We have also carried out transient response a detection on P3HT based diodes under high bias (500V). FIG. 4a is a single a particle signal and FIG. 4b shows a series of such signals. The variable signal height observed in FIG. 4b provides indication that the device operates in avalanche mode.

Diode devices can consist of sensitized dispersed bulk heterojunctions (e.g. D-A microsegregated blends, such as polymer:fullerene:BN) or of layered devices (e.g. organic hole transport layer perovskite electron transport/charge generation layer devices, e.g. polymer:BN nanoparticle:perovskite). The diodes can be defined by a high work function anode and a low work function cathode and may include additional charge injection layers between the electrodes and the semiconducting components. Multi-layer devices with dedicated hole and electron transport layers as well as charge generation layers are also possible. The diode thickness is desirably of the order of the Bragg peak position for the ionizing radiation emitted post neutron capture. Current changes can be measured either in the steady state or in transient response.

According to an embodiment of the invention, the sensitizer-containing organic semiconductor material is incorporated in a transistor, e.g. a field effect transistor or a bipolar junction transistor. By incorporating the sensitizer in an amplifying component, the signal can be amplified at the point of generation, increasing signal to noise ratio.

There are two primary modes of operation when the detector is realized using a FET architecture. The first mode of operation relies on charge carrier density changes induced in the transistor channel by the ionizing radiation produced post neutron capture leading to changes in the source-drain current. The second mode of operation relies on charge carriers being produced by the ionizing radiation in a suitably sensitized semiconducting region close to the gate electrode. The charges thus produced give rise to a current which in turn affects the gate electrode potential. The resulting gate electrode potential variation can, in turn lead to changes in either source drain current or measured turn on voltage, or both. Both modes of operation are designed to take advantage of the amplification behavior inherent in transistor components.

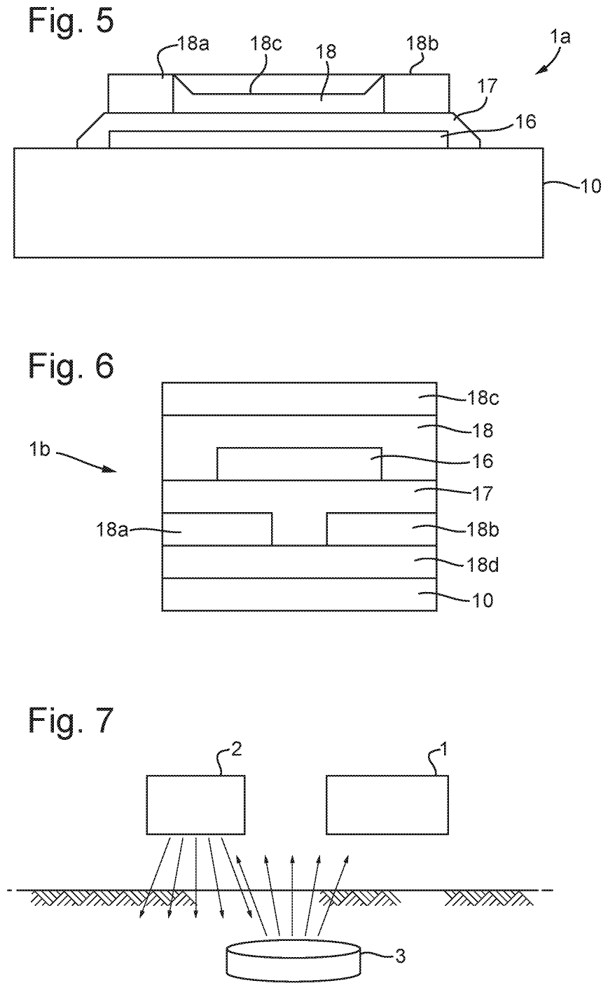

FIG. 5 depicts Field Effect Transistor (FET) device according to an embodiment of the invention using the channel carrier mode of operation. The FET detector 1a is a thin-film transition formed on substrate 10. Gate 16 is an electrode and is covered by insulator 17. A semiconductor layer 18 forms the channel between the source 18a and drain 18b electrodes. The organic semiconductor forming the channel may itself be sensitized, alternatively a layer, 18c (adjacent to the channel) may comprise of a sensitized organic semiconducting component. Thus the sensitizer may be incorporated in or adjacent to the transistor channel. The channel semiconductor may be formed of an organic semiconductor, hybrid or other (e.g. perovskite or graphene) material.

The operating principle of this type of device is that free charges generated in the sensitized organic component can migrate to the gate dielectric interface under the effect of the gate bias and affect the source-drain transistor current. The radiation can be detected by suitable changes in either the output or transfer behavior of the transistor and can be measured either in the steady state or in transient response. It is worth noting that the design depicted in FIG. 5 is a bottom gate, bottom source-drain example and that other structures, such as bottom gate, top source-drain, or top gate, top source-drain and other permutations of the design are also feasible so long as the channel and/or a layer adjacent to it are suitably sensitized.

FIG. 6 depicts a FET device according to an embodiment of the invention using the gate bias (voltage) variation mode of operation. The detector lb is fabricated on a substrate 10 and consists of a channel semiconductor 18d (which is not necessarily sensitized) and may be organic, perovskite or other e.g. graphene material). The source 18a and drain 18b electrodes are in contact with the channel and are separated by a dielectric 17 from the gate 16. The gate itself is in contact with a sensitized semiconductor layer 18 and the design allows for the inclusion of an additional sensitizer layer 18c adjacent to it. Additional sensitizer layer 18c may be provided on an outer (furthest from a substrate) side of the device and increases the probability of neutrons being captured.

Charge carriers generated in the sensitized semiconductor layer 18 (and/or additional sensitizer layer 18c if provided) by the secondary ionizing radiation will diffuse and/or drift, giving rise to a current. The current will flow into (or out of, depending on biasing) the gate 16. Since the external biasing circuit of the gate is fixed, this additional current will modify the gate voltage. FETs display extremely high transconductance in the vicinity of the turn-on voltage and small changes in the gate bias can result in large variations in the source-drain current. Thus the small radiation induced current in sensitized semiconductor layer 18 can be highly amplified. The example shown in FIG. 6 is a top gate, top source-drain example, but other architectures are also feasible, such as top gate, bottom source-drain or other permutations, so long as the gate is adjacent to a suitably sensitized semiconducting layer.

Using either FET mode of operation described, the radiation can be detected by suitable changes in either the output or transfer behavior of the transistor (or both) and can be measured either in the steady state or in transient response.

A variety of single and multiple detector architectures are possible. Individual detectors of arbitrary area can be manufactured. In the case of large area devices, individual detectors may be segregated (into quadrants, pixels or stripes, for example) to form multi-pixel detectors. The pixels may consist of separate diodes or FETs or both. Vertical integration (e.g. “tandem” or “stacked” detectors) is also possible. For example, a three dimensional pixelated and stacked all organic architecture could be used as a “phantom” for medical neutron beam applications.

Examples of organic semiconductors that can be used in the invention include Pi conjugated organic semiconductors (OSCs), which may include inorganic components (e.g. solution processable perovskites and nanoparticle sensitizers) for blends and multi-layer devices. The OSCs can be polymeric or small molecule based.

Desirably, the semiconducting components possess suitable bandgaps (of order eV) and selected electron affinities and ionization potentials (Highest Occupied Molecular orbital, HOMO, and Lowest Unoccupied Molecular Orbital, LUMO, level positions or Valence and Conduction bands in the inorganic case). The HOMO and LUMO levels are desirably suitable for constructing structures, e.g. diodes and Field Effect transistors (FETs). Where appropriate, charge carrier injection can occur from one or two electrodes if desired.

In the case of Donor-Acceptor (D-A) systems, the energetics are desirably tailored for electron transfer from the donor HOMO to the acceptor LUMO. The OSCs and/or inorganic components desirably possess reasonable charge carrier mobilities (at least 10⁻⁶ cm²V⁻¹s⁻¹, desirably 10⁻⁵ cm²V⁻¹s⁻¹ for at least one type of carrier) and ranges (of at least one type of carrier, this is desirably of the order of the Bragg peak position i.e. between 1 and 100 μm depending on the alpha energy post neutron capture).

The organic and inorganic components are desirably suitable for deposition such that the neutron capture sensitizer can be included as well as forming a controlled amount of D-A interface (or electron transport layer-hole transport layer interface) by micro segregation or layering. The sensitizer itself can consist of inorganic nanoparticles, such as BN or B₄C, or may be included as part of a metalo-organic complex, such as a Ga substituted Phthalocyanine.

The semiconductor component or components may be either fully organic or organic:inorganic hybrids e.g. polymer:fullerene:BN nanoparticle or polymer: polymer:nanoparticle or polymer:nanoparticle:perovskite, or polymer:metalo-organic complex. Individual components can perform more than one function (e.g. an electron acceptor or donor may also contain the sensitizer).

Embodiments of the invention allow high efficiency neutron detectors to be made with a commercially cheap process. In addition to high efficiency neutron detection, it is possible to make large area detectors that can be applied to scientific applications (particle and nuclear physics experiments), radiation dosimetry in laboratories, and radiation monitoring at commercial and government nuclear facilities such as operating and decommissioned reactors. Because it allows large scale detectors to be made economically, the present invention is particularly useful in security applications where large scale detectors can quickly scan people and/or freight.

Embodiments of the invention can also be employed in object detection e.g. mine detection. A mine detection device embodying the invention is depicted in FIG. 7. A neutron source 2 directs neutrons into the ground and a detector 1 detects the back-scattered neutrons. Differences in the back-scattering between earth and a mine 3 enable the mine to be detectable.

An organic semiconductor radiation detector according to the invention will naturally detect a particles and β particles and y radiation in addition to neutrons. If desired, the radiation detector can be made selective to neutrons and desired radiation by suitable encapsulation to exclude radiation types that are not of interest. In addition, the radiation detector can be made sensitive to x-rays by inclusion of an element having an atomic number greater than 20.

Manufacturing techniques that can be used in the invention include both solution processing techniques and non-solution processing techniques. Examples of suitable solution processing techniques include: drop-casting, spin coating, inkjet printing, screen printing, roll to roll printing. Examples of suitable non-solution processing techniques include: vacuum deposition and co-evaporation, solid state (high temperature and/or pressure) processing.

Having described embodiments of the invention, it will be appreciated that variations can be made to the described embodiments, which are intended to be illustrative not prescriptive. The invention is defined by the appended claims. References
[Ref 1] R. G. Fronk, S. L. Bellinger, L. C. Henson, T. R. Ochs, C. T. Smith, J. K. Shultis, D. S. McGregor, “Dual-Sided Microstructured Semiconductor Neutron Detectors (DSMSNDs),” Nucl. Instrum. Meth., A804 (2015) 201-206.

1. A radiation detector comprising a transistor formed of one or more organic semiconductor materials having a neutron sensitizer element dispersed therein.

2. A radiation detector according to claim 1 wherein the transistor is a field effect transistor.

3. A radiation detector according to claim 2 wherein the sensitizer is provided in the channel of the field effect transistor.

4. A radiation detector according to claim 2 wherein the sensitizer is provided in a layer of organic semiconductor adjacent the gate of the field effect transistor.

5. A radiation detector according to claim 4 further comprising an additional semiconductor layer containing sensitizer.

6. A radiation detector according to claim 1 wherein the sensitizer element is one or more elements selected from the group consisting of boron, cadmium, lithium and gadolinium.

7. A radiation detector according to claim 1 wherein the sensitizer element is provided in an amount of between 1×10²⁶ atoms/m³ and 1×10²⁸ atoms/m³ within the organic semiconductor material.

8. A radiation detector according to claim 1 wherein the sensitizer element is provided in the form of particles dispersed in the organic semiconductor material.

9. A radiation detector according to claim 1 wherein the sensitizer element is contained in an organic compound.

10. A radiation detector according to claim 1 wherein the sensitizer element is provided in the form of a plurality of layers embedded in the organic semiconductor material.

11. A radiation detector according to claim 1 wherein the organic semiconductor material has a charge carrier mobility of at least 10⁻⁶ cm²V⁻¹s⁻¹.

12. A radiation detector according to claim 1 wherein the organic semiconductor materials comprise a donor organic semiconductor material and an acceptor organic semiconductor material or a combination of organic and inorganic donor-acceptor materials.

13. A radiation detector according to claim 12 wherein the donor organic semiconductor component is electron-rich (has a smaller electron affinity) compared to the acceptor component.

14. A radiation detector according to claim 12 wherein the acceptor component is electron-deficient (has a larger electron affinity) compared to the donor, for example fullerene, fullerene derivative, pi-conjugated polymer, small molecule or perovskite.

15. A radiation detector according to claim 1 wherein the semiconductor device has a thickness in the range of from 1 μm to 500 μm.

16. A radiation detector according to claim 1 further comprising a bias voltage source configured to apply a potential difference in the range 1 V to 1 kV.

17. A radiation detector according to claim 1 containing sensitizer components additional to the neutron sensitizer, for example X-ray absorbers dispersed in the organic semiconductor material, the X-ray absorber comprising an element having an atomic number greater than 20.

18. An object detector comprising a radiation detector according to claim 1 and a neutron source.
